(19) United States
(12) Patent Application Publication
(10) Pub. No.: US 2008/0193252 A1
(43) Pub. Date: Aug. 14, 2008

(54) Fastener

(75) Inventor: Timothy John Roderic Barnsdale, Warwickshire (GB)

Correspondence Address: FULBRIGHT AND JAWORSKI LLP, 555 S. FLOWER STREET, 41ST FLOOR, LOS ANGELES, CA, 90071, US

(73) Assignee: Tappex Thread Inserts Limited, Warwickshire (GB)

(21) Appl. No.: 11/912,258

(22) PCT Filed: Apr. 20, 2006
(86) PCT No.: PCT/GB06/01455

§ 371 Date: Oct. 22, 2007

(30) Foreign Application Priority Data
Apr. 26, 2005 (GB) 0508397.7

(51) Int. Cl. F16B 37/12

(52) U.S. Cl. 411/109

(57) ABSTRACT

The present invention relates to an improved fastener, and, in particular, to a threaded fastener or insert arranged in use to be self threading into a workpiece having beneficial insertion and pull-out characteristics. A fastener is disclosed comprising a generally cylindrical body (12) about which is formed a thread (20), a first set of shaped flutes (22) formed in the fastener towards one end of the fastener extending from said one end at least a part of a longitudinal distance along the fastener, each of the shaped flutes (22) intersecting the thread (20) first on one side along a Hne parallel to a longitudinal axis of the fastener and on second side along an arcuate line, the shaped flutes (22) intersecting the thread (20) along the second side to define cutting edges (24) at the intersections, the cutting edges (24) acting to cut threads during use of the fastener, the radial outer edge of the thread (20) between the shaped flutes (22) having substantially constant radius and second set of flutes (30) formed in the thread, the second set of flutes (30) also intersecting the thread (20), the radial outer edge of the thread (20) between the second set of flutes (30) also having substantially constant radius.

The present invention relates to an improved fastener, and, in particular, to a threaded fastener or insert arranged in use to be self threading into a workpiece.

Such fasteners are typically provided with an internal thread and are inserted into a hole in a workpiece, such as a plastic workpiece, in order to receive a complementary fastening element. Such inserts are used where inserting the complementary fastening element directly into the workpiece would result in inadequate pull-out resistance and a weak re-usable thread, the workpiece invariably being of a lower tensile strength than the fastener. However it will be understood that there is a need to maintain tolerances on the dimensions of the hole for receiving the fastener and on the dimensions of the fastener itself to maintain cutting efficiency.

It is an advantage of the present invention that beneficial insertion and pull-out characteristics can be obtained. Other advantages of the invention will be made apparent below.

According to a first aspect of the present invention a fastener comprises a generally cylindrical body about which is formed a thread, a first set of shaped flutes formed in the fastener towards one end of the fastener extending from said one end at least a part of a longitudinal distance along the fastener, each of the shaped flutes intersecting the thread first on one side along a line parallel to a longitudinal axis of the fastener and on second side along an arcuate line, the shaped flutes intersecting the thread along the second side to define cutting edges at the intersections, the cutting edges acting to cut threads during use of the fastener, the radial outer edge of the thread between the shaped flutes having substantially constant radius and a second set of flutes formed in the thread, the second set of flutes also intersecting the thread, the radial outer edge of the thread between the second set of flutes also having substantially constant radius.

Preferably, each of the first set of shaped flutes extend into the generally cylindrical body of the fastener beyond the depth of the thread.

Preferably the first set of shaped flutes and the second set of flutes alternate about the circumference of the fastener body.

Preferably the first set of flutes and the second set of flutes are spaced equiangularly about the fastener body.

Preferably the flutes in the second set of flutes extend to less than half the depth of the thread.

Preferably the length of the thread between the flutes in the second set of flutes is greater than the lengths of the flutes in the circumferential direction.

According to a second aspect of the invention a fastener in accordance with the first aspect of the invention is inserted into a workpiece, in use, the thread of the fastener cutting a complementary thread on the workpiece, the depth of the complementary thread cut by the fastener thread being greater than the depth of the second set of flutes.

The invention will now be described, by way of example only, with reference to the accompanying drawings, in which:

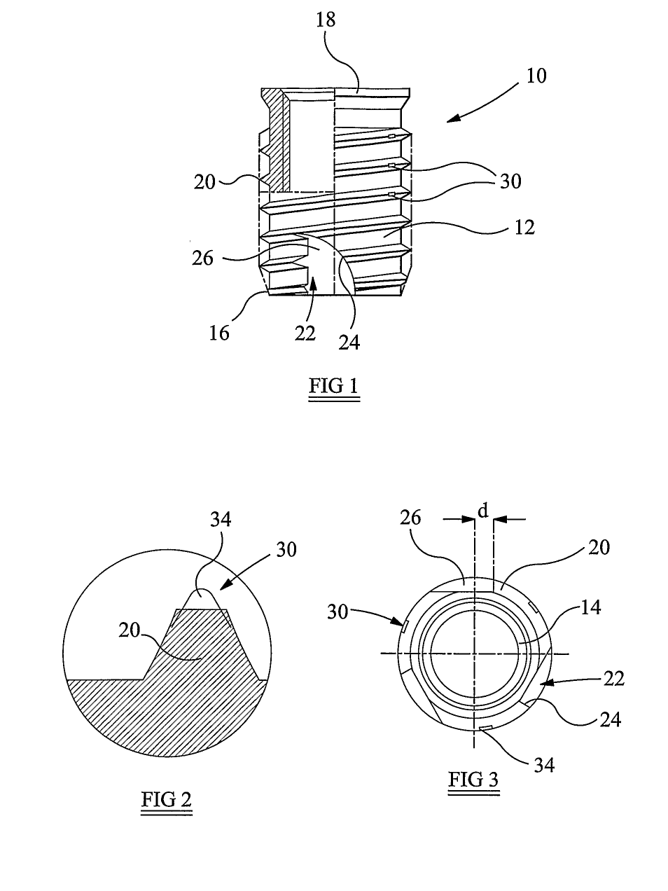

FIG. 1 shows a side view of a fastener in accordance with the present invention (part of which is shown in section along line A-A of FIG. 3);

FIG. 2 shows a section on line B-B of FIG. 1;

FIG. 3 shows an end view of the fastener shown in FIG. 1; and

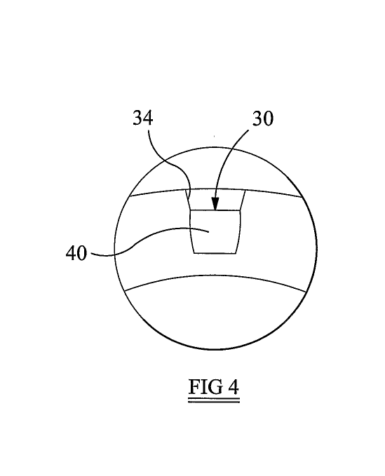

FIG. 4 shows an enlarged detail in the direction of arrow C of FIG. 1

Referring to the drawings a fastener 10 in accordance with the present invention is shown. The fastener 10 is in the form of a headed insert. The fastener comprises a cylindrical body 12 formed with an internal thread 14. In the illustrated embodiment, the body 12 is provided at a first end with a chamfer 16 to aid location and insertion in an opening in a workpiece (not shown). The fastener 10 is provided with a headed portion 18 in the form of a thickened portion or flange at a second end of the body 12.

A thread 20 is provided about the outer surface of the body 12, extending between the first end of the body 12 and the second end of the body 12. While in the illustrated embodiment a single thread is shown, the invention is contemplated for use with multi-start fasteners and accordingly references to a thread should be understood to apply to two or more threads for such a fastener. In the illustrated embodiment, it can be seen that the thread 20 carries the taper of the chamfer 16.

It will also be seen that the headed portion 18 extends radially only as far as does the thread 20. The headed portion 18 provides the fastener in use with a bearing surface against which a mating part may sit. The headed portion 18 also provides a stop to prevent the fastener being installed too far below the surface of the workpiece (incorrect location in this manner can leave an air gap into which the fastener may be jacked up as a complementary fastening element is tightened to the fastener 10).

The fastener 10 may be formed from any suitable material. Suitable materials include, but are not limited to, brass or steel.

A first set of grooves, notches or shaped flutes 22 are formed in the fastener at the first end of the fastener 10 extending from the first end at least a part of a longitudinal distance along the fastener 10. In the illustrated embodiment the first set of shaped flutes 22 comprises three identical such shaped flutes 22 equiangularly spaced about the fastener. Each of the shaped flutes 22 intersects the thread 20, first on one side along a line parallel to a longitudinal axis of the fastener and on a second side along an arcuate line, the shaped flutes 22 intersecting the thread along the second side to define cutting edges 24 at the intersections, the cutting edges 24 acting to cut threads during use of the fastener.

As seen from the first end the radial diameter of the thread 20 is initially at a minimum and, due to the chamfer, as the thread progresses around the fastener toward the second end, the outer diameter increases until the thread has a substantially constant radius. In use, the angle of the chamfer determines the distribution of cut swarf into the first shaped flutes 22.

As may be seen from FIG. 3, the shaped flutes 22 are formed as cutting flats 26 formed tangentially to the longitudinal axis of the fastener 10. While the shaped flutes 22 extend into the thickness of the body 12 of the fastener 10, they do not break through into the internal thread 14. This enables the body 12 to maintain its strength in use such that it does not collapse.

With further reference to FIG. 3 it may be seen that the cutting edges 24 of the shaped flutes 22 are each offset a distance ‘d’ from a centre line of the fastener 10. This offset creates a positive rake angle with sufficient sweep on the facet to enables swarf produced during the cutting process to be directed away from the thread 20 such that the swarf does not become jammed between the fastener 10 and the workpiece into which the fastener is being inserted.

At the first full thread after the lead-in chamfer, the cutting facet, as precisely shown at 24, is preferably still at an angle less than 90 degrees to the longitudinal to ensure that free cutting and dropping away of the cut swarf takes place at the major diameter of the external thread, after the lead-in chamfer has run out.

A second set of indents, groves or flutes 30 (shown in ghost in FIG. 3) are formed in the thread 20. The second set of flutes 30 are located towards the second end of the fastener 10 and are spaced equiangularly about the fastener. In the illustrated embodiment the second set of flutes 30 comprises three flutes 30, each of which extend parallel to the longitudinal axis of the fastener 10. Each of the second set of flutes 30 intersects thread 20 to define a set of partially cutting/partially forming edges 34 at the intersections. The thread 20 is partially radially inwardly deformed. The radial outer edge of the thread 20 between the second set of flutes 30 also maintains the substantially constant radius.

One of the second set of flutes 30 are shown in cross section in FIG. 4. Whereas the first set of flutes 22 have a positive cutting rake, the second set of flutes 30 have a negative rake angle, as their primary purpose is to deform the external thread 20 of the fastener 10.

In the illustrated embodiment, each of the second set of flutes 30 extends across three turns of the thread 20. However, they may extend across two or more turns of the thread. The second set of flutes 30 start only after the thread 20 extends beyond the first set of shaped flutes 22 and preferably only after the thread 20 has completed a complete sweep after being intersected by the first set of shaped flutes 22.

In the illustrated embodiment each of the flutes of the second set of flutes 30 is angularly located centrally between neighbouring shaped flutes 22 of the first set of shaped flutes 22.

In use the second set of flutes 30 provide a locking action to the fastener 10 when the fastener 10 is subject to vibration conditions. A full thread to the major diameter of the fastener is initially cut in the parent material of the workpiece. During a latter part of the installation process, the deformed thread 40 radially below flutes 30 locks into the cut thread. The second set of flutes 30 will also provide resistance to prevent unscrewing of the fastener 10 from a workpiece when a complementary fastening element such as a bolt is undone or becomes corroded.

1. A fastener comprising a generally cylindrical body (12) about which is formed a thread (20), a first set of shaped flutes (22) formed in the fastener towards one end of the fastener extending from said one end at least a part of a longitudinal distance along the fastener, each of the shaped flutes (22) intersecting the thread (20) first on one side along a line parallel to a longitudinal axis of the fastener and on second side along an arcuate line, the shaped flutes (22) intersecting the thread (20) along the second side to define cutting edges (24) at the intersections, the cutting edges (24) acting to cut threads during use of the fastener, the radial outer edge of the thread (20) between the shaped flutes (22) having substantially constant radius and a second set of flutes (30) formed in the thread, the second set of flutes (30) also intersecting the thread (20), the radial outer edge of the thread (20) between the second set of flutes (30) also having substantially constant radius.

2. A fastener according to claim 1, characterised in that each of the first set of shaped flutes (22) extend into the generally cylindrical body (12) of the fastener beyond the depth of the thread (20).

3. A fastener according to either claim 1 or claim 2, characterised in that the first set of shaped flutes (22) and the second set of flutes (30) alternate about the circumference of the fastener body (12).

4. A fastener according to any previous claim, characterised in that the first set of flutes (22) and the second set of flutes (30) are spaced equiangularly about the fastener body.

5. A fastener according to any previous claim, characterised in that the flutes in the second set of flutes (30) extend to less than half the depth of the thread (20).

6. A fastener according to any previous claim, characterised in that the length of the thread (20) between the flutes in the second set of flutes (30) is greater than the lengths of the flutes in the circumferential direction.

7. A fastener in accordance with any previous claim in which when the fastener is inserted into a workpiece, the thread (20) of the fastener cuts a complementary thread on the workpiece, the depth of the complementary thread cut by the fastener thread (20) being greater than the depth of the second set of flutes (30).
